(19) United States
(12) Patent Application Publication
(10) Pub. No.: US 2020/0148188 A1
(43) Pub. Date: May 14, 2020

(54) LDC-INTEGRATED BATTERY MANAGEMENT DEVICE AND METHOD FOR 48V MILD HYBRID SYSTEM

(71) Applicant: HYUNDAI MOBIS Co., LTD., Seoul (KR)

(72) Inventor: Il Han KIM, Yongin-si (KR)

(21) Appl. No.: 16/670,938

(22) Filed: Oct. 31, 2019

(30) Foreign Application Priority Data
Nov. 14, 2018 (KR) 10-2018-0139814

(51) Int. Cl. B60W 20/10; B60W 10/06; B60W 10/08; B60W 30/18; B60K 6/26; B60K 6/28; B60L 3/12

(52) U.S. Cl. CPC B60W 20/10; B60Y 2306/05; B60W 10/08; B60W 30/18127; B60K 6/26; B60K 6/28; B60L 3/12; B60W 2510/244; B60W 2710/08; B60W 2400/00; B60K 2006/268; B60Y 2200/92; B60Y 2300/18125; B60Y 2400/47; B60Y 2400/112; B60W 10/06

(57) ABSTRACT

A low DC-DC converter (LDC)-integrated battery management device for a 48V mild hybrid system includes an low DC-DC converter (LDC)-integrated battery management device for a 48V mild hybrid system, in which a battery management system and an LDC of a 48V mild hybrid system, which are each controlled by a electronic control unit (ECU), are integrally managed.

### CROSS-REFERENCE TO RELATED APPLICATION

This application claims priority from and the benefit of Korean Application No. 10-2018-0139814 filed on Nov. 14, 2018, which is hereby incorporated by reference for all purposes as if set forth herein.

### BACKGROUND

### Field

Exemplary embodiments relate to low DC-DC converter (LDC)-integrated battery management device for a 48V mild hybrid system, and more particularly, to LDC-integrated battery management device for a 48V mild hybrid system, in which a conventional LDC and a 48V battery module independently provided are integrated into one component, an initial driving function of a starter generator is implemented in software, and thus a pre-charging relay and a charging resistor are removed.

### Discussion of the Background

In general, mild hybrid systems using battery cells include a battery cell management assembly configured to control the battery cells for supplying a voltage of 48V, a 12V battery configured to supply a voltage of 12V to electronic devices, a starting generator, that is, a 48V mild hybrid starter and generator (MHSG) configured to assist in a driving force of an engine using the voltage of 48V applied from the battery cell and having a regenerative braking function which charges a battery during decelerating of a vehicle, a 48V low DC-DC converter (LDC) configured to supply power to 12V electronic components, and an equipment management controller configured to control each component using a controller area network (CAN).

In the conventional mild hybrid system using the battery cell, the 48V LDC and the battery cell management assembly are independently separated. As a result, control units for the 48V LDC and a battery management system are inevitably separated.

Thus, the 48V LDC and the battery management system perform functions thereof in an independent assembly manner.

In addition, the equipment management controller controls the charging of battery cells of the battery management system at the start of an engine through a voltage of a DC link capacitor (CAP).

Meanwhile, the conventional battery cell management assembly supplies a voltage of 48V to the 48V LDC and the 48V MHSG.

However, in the conventional mild hybrid systems using the battery cells, since the battery cell management assembly and the 48V LDC are independently provided, manufacturing costs for housings and boards of the battery cell management assembly and the 48V LDC are doubled, and separate software is also required for each of them.

In addition, since the battery cell management assembly and the 48V LDC are independently provided, additional labor cost is required for mounting the battery cell management assembly and the 48V LDC in a vehicle, and thus, mounting spaces thereof should be secured in the vehicle.

The above information disclosed in this Background section is only for enhancement of understanding of the background of the invention and, therefore, it may contain information that does not constitute prior art.

### SUMMARY

Exemplary embodiments of the present invention provide an low DC-DC converter (LDC)-integrated battery management device for a 48V mild hybrid system, in which a battery management system and an LDC of a 48V mild hybrid system, which are each controlled by a electronic control unit (ECU), are integrally managed.

The above mentioned objects of the present invention are not limited thereto, and other objects belonging to the present invention can be obviously understood along with the descriptions below.

According to exemplary embodiments of the current disclosure, a low DC-DC converter (LDC)-integrated battery management device for a 48V mild hybrid system, including: a mild hybrid starter and generator (MHSG) configured to: charge a 48V battery cell through regenerative braking during decelerating of a vehicle; and assist in a driving force of an engine during traveling of the vehicle; a 12V battery configured to apply a 12V voltage for turning on an ignition of the vehicle; an LDC-integrated battery module configured to: perform a self-diagnosis using the 12V voltage applied from the 12V battery; generate a boosted 48V voltage by converting the 12V voltage to the 48V voltage according to a result of the self-diagnosis; and apply the boosted 48V voltage to the 48V battery cell and the MHSG; and an equipment management controller configured to: apply the 12V voltage applied from the 12V battery to the LDC-integrated battery module in response to the ignition of the vehicle being tuned on; and control the LDC-integrated battery module to apply the boosted 48V voltage generated through the LDC-integrated battery module to the battery cell and the MHSG.

The LDC-integrated battery module may include: the 48V battery cell configured to charge with and discharge the 48V voltage; a switching unit configured to: apply the 48V voltage applied through the MHSG to charge the 48V battery cell and perform a switching operation such that the engine is driven using the 48V voltage of the 48V battery cell; an integrated control unit configured to control the switching unit to charge and discharge the 48V battery cell in response to the 12V voltage being applied from the 12V battery; and a cooling unit configured to cool the 48V battery cell and the integrated control unit.

The integrated control unit may be configured to: compare an output voltage of an LDC boost mode with an actual voltage of the 48V battery cell; relay the switching unit to charge the 48V battery cell using the boosted 48V voltage in response to a difference between the output voltage of the LDC boost mode and the actual voltage of the 48V battery cell being greater than or equal to a preset voltage value.

The LDC-integrated battery module may be configured to perform a self-diagnosis in response to the ignition of the vehicle being turned on and the 12V voltage being applied, and the LDC-integrated battery module, in response to a result of the self-diagnosis being the LDC-integrated battery module in a normal state, may be configured to: convert the 12V voltage into the boosted 48V voltage; and charge a DC link capacitor of the MHSG with the boosted 48V voltage.

The LDC-integrated battery module, in response to a result of the self-diagnosis being the LDC-integrated battery module in an abnormal state, may be configured to: count the number of abnormal instances; and operate a warning lamp and stop a process of converting the 12V voltage into the boosted 48V voltage, in response to the number of abnormal instances reaching a preset number of counts.

In response to the 12V voltage being boosted to the boosted 48V voltage and the DC link CAP of the MHSG being charged by the boosted 48V voltage, the LDC-integrated battery module may be configured to: compare the boosted 48V voltage with a reference voltage level obtained by multiplying a voltage of the 48V battery cell by a reference ratio of a charging voltage of the DC link CAP, and boost the boosted 48V voltage to a voltage level equal to the reference voltage level in response to the reference voltage level being greater than or equal to the boosted 48V voltage.

The LDC-integrated battery module may be configured to stop an operation of converting the 12V voltage to the boosted 48V voltage in response to an LDC idle mode request being input from the equipment management controller.

According to the exemplary embodiments of the present disclosure, a low DC-DC converter (LDC)-integrated battery management method for a 48V mild hybrid system performed by a 48V mild hybrid system including a 12V battery, a mild hybrid starter and generator MHSG, an LDC-integrated battery module including a 48V battery cell, and an equipment management controller, the LDC-integrated battery management method including; receiving, by the LDC-integrated battery module, a 12V voltage from the 12V battery, in response to turning on an ignition of a vehicle; performing, by the LDC-integrated battery module, a self-diagnosis to determine whether a problem occurs; boosting, by the LDC-integrated battery module, the received 12V voltage to generate a boosted 48V voltage in response to determining that the problem did not occur; applying, by the LDC-integrated battery module, the boosted 48V voltage to the MHSG; and controlling, by the LDC-integrated battery module, a switching unit to charge the 48V battery cell with the boosted 48V voltage according to a difference between the boosted 48V voltage and a voltage level of the 48V battery cell.

The applying of the 48V voltage to the MHSG may include: comparing the boosted 48V voltage with a reference voltage level obtained by multiplying a voltage of the 48V battery cell by a reference ratio of a charging voltage of a DC link capacitor; and boosting the 48V voltage to a voltage level equal to the reference voltage level in response to the reference voltage level being greater than or equal to the boosted 48V voltage.

The controlling of the switching unit to charge the 48V voltage may include: determining, by the LDC-integrated battery module, whether the boosted 48V voltage is less than a reference voltage level obtained by multiplying a 48V voltage of the 48V battery cell by a reference ratio of a charging voltage of a DC link CAP; and controlling, by the LDC-integrated battery module, the switching unit to control charging and discharging of the 48V battery cell for 48V voltage, in response to determining that the boosted 48V voltage is less than the reference voltage level.

The LDC-integrated battery module may be configured to stop an operation of converting the 12V voltage to the boosted 48V voltage during the charging of the 48V voltage in a DC link CAP of the MHSG in response to an LDC idle mode request being input from the equipment management controller.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a functional block diagram for describing a low DC-DC converter (LDC)-integrated battery management device for a 48V mild hybrid system according to an exemplary embodiment of the present invention.

FIG. 2 is a diagram for describing a detailed configuration of the LDC-integrated battery module according to the exemplary embodiment of the present invention.

FIG. 3 is a flowchart for describing an LDC-integrated battery management method for a 48V mild hybrid system according to an exemplary embodiment of the present invention.

FIG. 4 is a flowchart for describing an operation of applying a voltage of 48V to a starter generator (100) according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Advantages and features of the present invention and methods for accomplishing the same will be more clearly understood from exemplary embodiments described below with reference to the accompanying drawings. However, the present invention is not limited to the following exemplary embodiments but may be implemented in various different forms. The exemplary embodiments are provided only to complete the disclosure of the present invention and to fully provide a person having ordinary skill in the art to which the present invention pertains with the scope of the present invention, and the present invention will be defined by the appended claims. Terms used in this specification are to describe the exemplary embodiments and are not intended to limit the present invention. As used herein, singular expressions, unless defined otherwise in contexts, include plural expressions. It will be further understood that the terms “comprises,” “comprising,” “includes,” and/or “including,” if used herein, specify the presence of stated components, steps, operations, and/or elements, but do not preclude the presence or addition of one or more other components, steps, operations, and/or elements.

It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

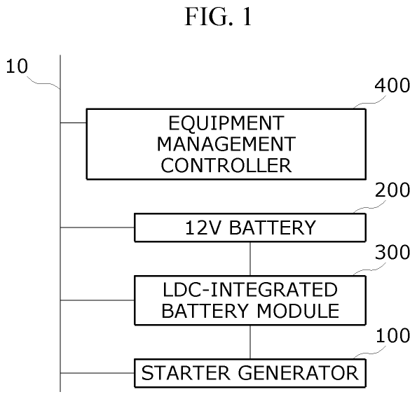

Hereinafter, exemplary embodiments of the present invention will be described in detail with reference to the accompanying drawings. FIG. 1 is a functional block diagram for describing a low DC-DC converter (hereinafter, referred to as “LDC”)-integrated battery management device for a 48V mild hybrid system according to an exemplary embodiment of the present invention.

As shown in FIG. 1, the LDC-integrated battery management device for a 48V mild hybrid system according to the exemplary embodiment of the present invention includes a starter generator 100, a 12V battery 200, an LDC-integrated battery module 300, and an equipment management controller 400.

The starter generator 100 serves to charge a battery cell through regenerative braking during decelerating of a vehicle and assist in a driving force of an engine during traveling of the vehicle. The starter generator 100 is a mild hybrid starter and generator (MHSG).

When an ignition of the vehicle is turned on, the 12V battery 200 serves to apply a voltage of 12V to the starter generator 100 and each electronic component of the vehicle.

The LDC-integrated battery module 300 performs a self-diagnosis using the voltage of 12V applied from the 12V battery 200 and then serves to convert a voltage of 12V to a voltage of 48V and supply the voltage of 48V to the battery cell and the starter generator 100 according to a result of the diagnosis.

In addition, when the ignition of the vehicle is tuned on, the equipment management controller 400 serves to control the 12V battery 200 through a controller area network (CAN) communication protocol such that the voltage of 12V of the 12V battery 200 is applied to the LDC-integrated battery module 300. In addition, the equipment management controller 400 serves to control the LDC-integrated battery module 300 through the CAN communication protocol such that the voltage of 48V converted through the LDC-integrated battery module 300 is applied to the battery cell and the starter generator 100.

According to the exemplary embodiment of the present invention, as in the related art, since an LDC and a 48V battery management module are independently provided, when an ignition of a vehicle is turned on, a voltage is supplied to a starter generator using software, thereby removing a pre-charging relay and a charging resistor conventionally required for supplying a voltage to the starter generator to reduce costs and man-hours for constituting a system.

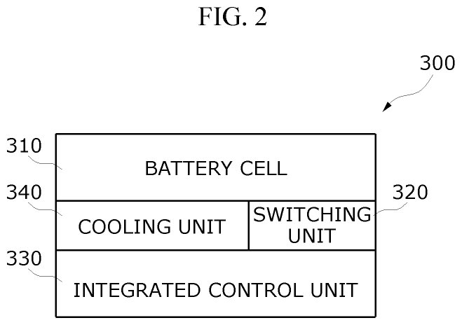

FIG. 2 is a diagram for describing a detailed configuration of the LDC-integrated battery module according to the exemplary embodiment of the present invention.

As shown in FIG. 2, the LDC-integrated battery module 300 includes a battery cell 310, a switching unit 320, an integrated control unit 330, and a cooling unit 340.

The battery cell 310 is charged with or discharges a voltage of 48V.

The switching unit 320 serves to charge a voltage of 48V applied through the starter generator 100 in the battery cell 310 and perform a switching operation such that the engine is driven using the voltage of 48V of the battery cell 310.

In addition, when the voltage of 12V is applied from the 12V battery 200, the integrated control unit 330 serves to control the switching unit 320 to charge and discharge the battery cell 310.

The cooling unit 340 is disposed between the battery cell 310 and a board of the integrated control unit 330 and serves to cool the battery cell 310 and the integrated control unit 330.

Here, the integrated control unit 330 compares an output voltage of an LDC boost mode with an actual voltage of the battery cell 310. When a difference between the output voltage of the LDC boost mode and the actual voltage of the battery cell 310 is greater than or equal to a preset voltage value, the integrated control unit 330 controls the switching unit such that the boosted voltage of 48V is charged in the battery cell 310.

Meanwhile, when an ignition of a vehicle is turned on and a voltage of 12V is applied, the LDC-integrated battery module 300 performs a self-diagnosis.

Then, when the LDC-integrated battery module 300 is in a normal state according to a result of the diagnosis, the LDC-integrated battery module 300 converts the voltage of 12V into a voltage of 48V (of an LDC boost mode) and charges the voltage of 48V in a DC link capacitor (CAP) of the starter generator 100.

Meanwhile, when the LDC-integrated battery module 300 is in an abnormal state according to the result of the self-diagnosis, the LDC-integrated battery module 300 counts the number of abnormal instances. When the number of abnormal instances reaches a preset number of counts, the LDC-integrated battery module 300 operates a warning lamp and stops a process of converting the voltage of 12V into the voltage of 48V.

In addition, when a voltage of 12V is boosted to a voltage of 48V and the voltage of 48V is charged in the DC link CAP of the starter generator 100, the LDC-integrated battery module 300 compares a value with the boosted voltage of 48V, wherein the value is obtained by multiplying a voltage of the battery cell 310 by a reference ratio of a charging voltage of the DC link CAP. As a result of the comparison, the LDC-integrated battery module 300 boosts the boosted voltage of 48V to a level at which the value obtained by multiplying the voltage of the battery cell 310 by the reference ratio of the charging voltage of the DC link CAP is greater than or equal to an output voltage of the boosted voltage of 48V.

When an LDC idle mode request is input from the equipment management controller 400, the LDC-integrated battery module 300 stops an operation of converting the voltage of 12V to the voltage of 48V (LDC boost mode).

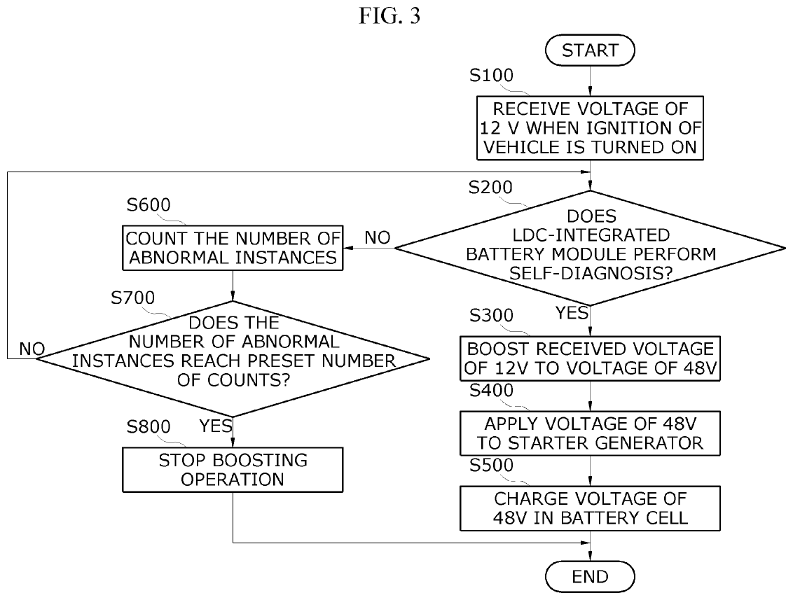

Hereinafter, an LDC-integrated battery management method for a 48V mild hybrid system according to an exemplary embodiment of the present invention will be described below with reference to FIG. 3.

The LDC-integrated battery management method for a 48V mild hybrid system according to the exemplary embodiment of the present invention is performed by a 48V mild hybrid system including a 12V battery 200, a starter generator 100, an LDC-integrated battery module 300 including a battery cell 310, and an equipment management controller 400.

First, when an ignition of a vehicle is turned on, the LDC-integrated battery module 300 receives a voltage of 12V from the 12V battery 200 (S100).

Next, the LDC-integrated battery module 300 performs a self-diagnosis and determines whether a problem occurs (S200).

When it is determined in operation S200 that the problem does not occur (YES), the LDC-integrated battery module 300 boosts the received voltage of 12V to a voltage of 48V (S300).

Then, the LDC-integrated battery module 300 applies the voltage of 48V to the starter generator 100 (S400).

Meanwhile, the LDC-integrated battery module 300 controls a switching unit to charge the voltage of 48V in the battery cell according to a difference between the boosted voltage of 48V and a voltage of the battery cell for 48V (S500).

According to the exemplary embodiment of the present invention, as in the related art, since an LDC and a 48V battery management module are independently provided, when an ignition of a vehicle is turned on, a voltage is supplied to a starter generator using software, thereby removing a pre-charging relay and a charging resistor conventionally required for supplying a voltage to the starter generator to reduce costs and man-hours for constituting a system.

Meanwhile, when it is determined in operation S200 that the problem occurs (NO), the LDC-integrated battery module 300 counts the number of abnormal instances (S600). When the number of abnormal instances reaches a preset number of counts (YES), the LDC-integrated battery module 300 operates a warning lamp and stops a process of converting the voltage of 12V into the voltage of 48V (S700). When the number of abnormal instances does not reach the preset number of counts (NO), the process returns to operation S200 in which the LDC-integrated battery module performs the self-diagnosis.

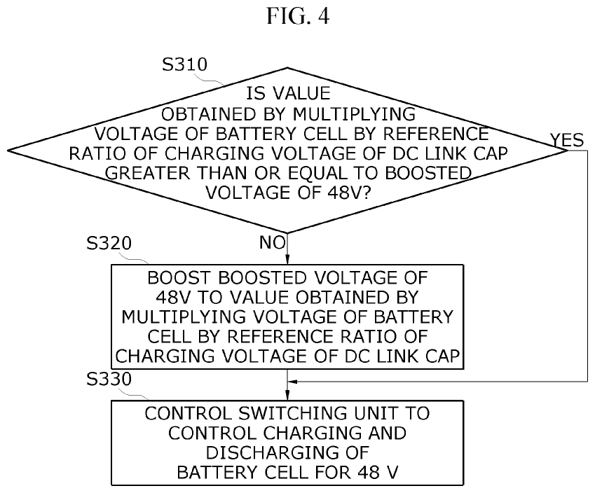

FIG. 4 is a flowchart for describing an operation of applying a voltage of 48V to the starter generator 100 according to an exemplary embodiment of the present invention.

As shown in FIG. 4, a boosted voltage of 48V is compared with a value obtained by multiplying a voltage of the battery cell 310 by a reference ratio of a charging voltage of a DC link CAP (S310).

When the boosted voltage of 48V is less than the value obtained by multiplying the voltage of the battery cell 310 by the reference ratio of the charging voltage of the DC link CAP, the boosted voltage of 48V is boosted to the value obtained by multiplying the voltage of the battery cell 310 by the reference ratio of the charging voltage of the DC link CAP (S320).

When the boosted voltage of 48V is greater than or equal to the value obtained by multiplying the voltage of the battery cell 310 by the reference ratio of the charging voltage of the DC link CAP (YES), the LDC-integrated battery module 300 controls the switching unit to control charging and discharging of the battery cell for 48V (S330).

Meanwhile, in an operation of charging a voltage of 48V in the DC link CAP of the starter generator 100, when an LDC idle mode request is input from the equipment management controller 400, the LDC-integrated battery module 300 stops an operation of converting the voltage of 12V to the voltage of 48V (LDC boost mode).

According to an exemplary embodiment of the present invention, an LDC and a battery cell of an LDC-integrated battery management system can be controlled in a software manner using a single controller to provide functions of a relay and a charging resistor for pre-charging an MHSG of a conventional mild hybrid system, thereby removing components for pre-charging the MHSG to reduce costs and man-hours.

In the charging of the voltage of 48V in a DC link CAP of the MHSG, when an LDC idle mode request is input from the equipment management controller, the LDC-integrated battery module may stop an operation of converting the voltage of 12V to the voltage of 48V (LDC boost mode).

Although the configurations of the present invention have been described in detail above with reference to the accompanying drawings, these are mere examples, and those of ordinary skill in the technical field to which the present invention pertains can make various modifications and changes within the technical spirit of the present invention. Therefore, the scope of the present invention should not be limited by the above-described exemplary embodiments but should be determined by the following claims.

What is claimed is:

1. A low DC-DC converter (LDC)-integrated battery management device for a 48V mild hybrid system, comprising:
a mild hybrid starter and generator (MHSG) configured to:
charge a 48V battery cell through regenerative braking during decelerating of a vehicle; and
assist in a driving force of an engine during traveling of the vehicle;
a 12V battery configured to apply a 12V voltage for turning on an ignition of the vehicle;
an LDC-integrated battery module configured to:
perform a self-diagnosis using the 12V voltage applied from the 12V battery;
generate a boosted 48V voltage by converting the 12V voltage to the 48V voltage according to a result of the self-diagnosis; and
apply the boosted 48V voltage to the 48V battery cell and the MHSG; and
an equipment management controller configured to:
apply the 12V voltage applied from the 12V battery to the LDC-integrated battery module in response to the ignition of the vehicle being tuned on; and
control the LDC-integrated battery module to apply the boosted 48V voltage generated through the LDC-integrated battery module to the battery cell and the MHSG.

2. The LDC-integrated battery management device of claim 1, wherein the LDC-integrated battery module comprises:
the 48V battery cell configured to be charged with and discharge the 48V voltage;
a switching unit configured to:
apply the 48V voltage applied through the MHSG to charge the 48V battery cell and
perform a switching operation such that the engine is driven using the 48V voltage of the 48V battery cell;
an integrated control unit configured to control the switching unit to charge and discharge the 48V battery cell in response to the 12V voltage being applied from the 12V battery; and
a cooling unit configured to cool the 48V battery cell and the integrated control unit.

3. The LDC-integrated battery management device of claim 2, wherein the integrated control unit is configured to:
compare an output voltage of an LDC boost mode with an actual voltage of the 48V battery cell;
relay the switching unit to charge the 48V battery cell using the boosted 48V voltage in response to a difference between the output voltage of the LDC boost mode and the actual voltage of the 48V battery cell being greater than or equal to a preset voltage value.

4. The LDC-integrated battery management device of claim 1, wherein the LDC-integrated battery module is configured to perform a self-diagnosis in response to the ignition of the vehicle being turned on and the 12V voltage being applied, and
wherein the LDC-integrated battery module, in response to a result of the self-diagnosis being the LDC-integrated battery module in a normal state, is configured to:
convert the 12V voltage into the boosted 48V voltage; and
charge a DC link capacitor of the MHSG with the boosted 48V voltage.

5. The LDC-integrated battery management device of claim 1, wherein the LDC-integrated battery module, in response to a result of the self-diagnosis being the LDC-integrated battery module in an abnormal state, is configured to:
count a number of abnormal instances; and
operate a warning lamp and stop a process of converting the 12V voltage into the boosted 48V voltage, in response to the number of abnormal instances reaching a preset number of counts.

6. The LDC-integrated battery management device of claim 5, wherein, in response to the 12V voltage being boosted to the boosted 48V voltage and a DC link capacitor of the MHSG being charged by the boosted 48V voltage, the LDC-integrated battery module is configured to:
compare the boosted 48V voltage with a reference voltage level obtained by multiplying a voltage of the 48V battery cell by a reference ratio of a charging voltage of the DC link capacitor, and
boost the boosted 48V voltage to a voltage level equal to the reference voltage level in response to the reference voltage level being greater than or equal to the boosted 48V voltage.

7. The LDC-integrated battery management device of claim 4, wherein the LDC-integrated battery module is configured to stop an operation of converting the 12V voltage to the boosted 48V voltage in response to an LDC idle mode request being input from the equipment management controller.

8. A low DC-DC converter (LDC)-integrated battery management method for a 48V mild hybrid system performed by a 48V mild hybrid system comprising a 12V battery, a mild hybrid starter and generator (MHSG), an LDC-integrated battery module comprising a 48V battery cell, and an equipment management controller, the LDC-integrated battery management method comprising;
receiving, by the LDC-integrated battery module, a 12V voltage from the 12V battery, in response to turning on an ignition of a vehicle;
performing, by the LDC-integrated battery module, a self-diagnosis to determine whether a problem occurs;
boosting, by the LDC-integrated battery module, the received 12V voltage to generate a boosted 48V voltage in response to determining that the problem did not occur;
applying, by the LDC-integrated battery module, the boosted 48V voltage to the MHSG; and
controlling, by the LDC-integrated battery module, a switching unit to charge the 48V battery cell with the boosted 48V voltage according to a difference between the boosted 48V voltage and a voltage level of the 48V battery cell.

9. The LDC-integrated battery management method of claim 8, wherein the applying of the 48V voltage to the MHSG comprises:
comparing the boosted 48V voltage with a reference voltage level obtained by multiplying a voltage of the 48V battery cell by a reference ratio of a charging voltage of a DC link capacitor; and
boosting the 48V voltage to a voltage level equal to the reference voltage level in response to the reference voltage level being greater than or equal to the boosted 48V voltage.

10. The LDC-integrated battery management method of claim 8, wherein the controlling of the switching unit to charge the 48V voltage comprises:
determining, by the LDC-integrated battery module, whether the boosted 48V voltage is less than a reference voltage level obtained by multiplying a 48V voltage of the 48V battery cell by a reference ratio of a charging voltage of a DC link capacitor; and
controlling, by the LDC-integrated battery module, the switching unit to control charging and discharging of the 48V battery cell for 48V voltage, in response to determining that the boosted 48V voltage is less than the reference voltage level.

11. The LDC-integrated battery management method of claim 8, wherein the LDC-integrated battery module is configured to stop an operation of converting the 12V voltage to the boosted 48V voltage during the charging of the 48V voltage in a DC link capacitor of the MHSG in response to an LDC idle mode request being input from the equipment management controller.
